(19) United States
(12) Patent Application Publication
(10) Pub. No.: US 2026/0111429 A1
(43) Pub. Date: Apr. 23, 2026

(54) Method and System for Deploying Artificial Intelligence Without Traditional Training

(71) Applicant: Advanced Symbolics (2015) Inc., Ottawa (CA)

(72) Inventors: John Kenton White, Ottawa (CA); Anubhav Chhabra, ottawa (CA); Shainen Davidson, Ottawa (CA)

(21) Appl. No.: 19/331,546

(22) Filed: Sep. 17, 2025

Related U.S. Application Data
(60) Provisional application No. 63/709,472, filed on Oct. 20, 2024.

(51) Int. Cl. G06F 16/2458

(52) U.S. Cl. CPC G06F 16/2465

(57) ABSTRACT

A method is disclosed for training a correlation engine. A first stance is automatically determined for a first group of users. The first stance and first information related to the first group of users is provided to a first correlation engine as training data to result in a first trained correlation engine. Similar information types to the first information and related to other users is provided to the trained correlation engine. In response, the trained correlation engine classifies the other users into those with the first stance and those without the first stance.

### FIELD OF THE INVENTION

The invention relates generally to computers and more particularly to a method and system for deploying correlation engines.

### BACKGROUND

Artificial intelligence (AI), as it is called, typically involves a data architecture that when provided many example data points - input data and output data-becomes capable of correlating data received to provide an output classification. Thus, what we typically refer to as AI is one or more correlation engine that receive real world data and then translate that real world data into an output class. For example, AI is used in optical character recognition where it is provided an image of a character with the hope that it will classify the image into a class reflective of that character. For Capitalised English characters, that would be a classifier for classifying images into 26 different classes.

To achieve this correlation based on training data, a correlation engine-a black box—receives input data in a certain form and provides an output class in a specific form based on a correlation. What happens within the classification engine is typically not considered relevant to its use. An image provided to a correlation engine might result in a character, a name of an animal within the image, a uniform resource locator (URL) of a similar image, etc. Thus, each image provided to the correlation engine—the AI—is classified. Of course, training of correlation models with erroneous data often results in erroneous classification.

Large Language Models (LLMs), in contrast, rely on much more complex correlations to perform much more complex tasks. To train an LLM, therefore, one provides correlation training data and training tasks to train the model. Then, human tuning and human fine tuning is used to improve on the resulting correlations. Sometimes, this process is iterated to achieve a desired set of correlations. It is an onerous task performed through automated data scraping and human intervention. AI, unlike true intelligence, does not discern between available data other than algorithmically or through tuning by a human.

In a Nov. 18, 2020 article in the MIT Technology Review, it was put forward that under-specification of correlation engines is a major concern. From the article, ‘The Way We Train AI is Fundamentally Flawed,’ it is evident that knowledge of the performance of a correlation processor is very difficult to determine; there exists a chicken—egg problem. There is no way to reasonably evaluate the difficulties a complex correlation processor will encounter once it leaves training. Even small extensions beyond the boundary of expectations, might lead to surprisingly wonderful or surprisingly unreliable classification.

As the term artificial Intelligence implies, the field is looking to create intelligence other than from organic life. However, intelligence is not merely a correlation. When a child sees a rose, even without language they can evaluate and learn about the rose. Language helps them to express concepts to others—to share a common base of understanding—but is not necessary for intelligence. In fact, a child could learn all about different flowers, where they grow and how they appear, without ever labeling the flowers at all. To the child, this apparent soft red item opens from a bud on a branch with thorns, smells a certain way and lasts a certain length of time before parts fall off. To the child, there is another soft white item that is analogous, and hence the use of correlation engines for artificial intelligence, because eventually knowledge is compressed through analogs. These analogs are viewed programmatically as classifications; in reality, that is only one way to explain them.

It would be advantageous to provide a different model for artificial intelligence.

### SUMMARY OF EMBODIMENTS

In accordance with an embodiment there is provided a method comprising: providing a first correlation engine; in a training mode of operation, providing to the first correlation engine for each of a first plurality of first users, a plurality of first available data about each first user of the first plurality of first users and a first stance of each first user relating to a first query; and in an operational mode providing to the first correlation engine a plurality of available data relating to a first new user, the first correlation engine providing a first output estimated stance for the first query for the first new user.

In accordance with an embodiment there is provided a method comprising: automatically determining a stance for each of a plurality of groups of users, the same stance determined for members of the plurality of groups of users; using the determined stance as correct output values for training a plurality of correlation engines, each correlation engine trained with each determined stance from a group of the plurality of groups and data available and relating to users within the group of the plurality of groups for whom a same stance is detected; for each user within a population of users, executing each of the plurality of correlation engines to determine a plurality of output values, each output value relating to a different correlation engine; and comparing output values from the plurality of output values one against another to determine at least one of a degree to which the output values relating to a particular user and a likelihood that the output values relating to a particular user are correct.

In accordance with an embodiment there is provided a method comprising: providing a first correlation engine; automatically determining a first stance of a first user; using the first stance as known output data for training the first correlation engine; using publicly available data relating to the first user as training input data; and training the first correlation engine with the known output data and the training input data.

In some embodiments the publicly available data comprises social media feed data.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified flow diagram of a process for resulting in a correlation engine.

FIG. 2 is a simplified flow diagram of a process for forming a correlation engine according to an embodiment.

FIG. 3 is a simplified flow diagram of a process similar to that of FIG. 2, but extended to 10 stances each determined for a same or different groups of users.

FIG. 4 is a simplified flow diagram of a method of using stance to “train” a correlation engine.

FIG. 5 is a simplified flow diagram of a method of using stance to train a classifier wherein a first user responds to the survey erroneously.

FIG. 6 is a simplified flow diagram of a method of learning about a user by seeking further data when classification results are different from expected classification results.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Artificial Intelligence (AI): Artificial intelligence is a field of computer science that aims to generate software that mimics all or part of human intelligence.
‘against’ is used herein and in the claims that follow to indicate a bias or stance relative to a query or statement; ‘against’ as used herein refers to a negative response to a query or a stance against a statement or hypothesis.
Artificial Intelligence (AI) system refers to correlation processing relying on training to produce a model, the model relied upon to correlate input values to output values.
Artificial Intelligence (AI) model is a model formed by training an artificial intelligence system with input data and known output data relating to the input data. Training the artificial intelligence system results in a dataset for correlating input data to output data, the dataset forms the artificial intelligence model.
Automatically trained models are artificial intelligence models that are trained through an automated process, either with updated information provided over time or with automated data analysis used to estimate output values for a given input value.
Bias refers to a statistical closeness or distance from a given statement within a piece of content. Bias includes unrecognised bias, such as repeating untrue but believable tropes that are associated with a position on an issue, recognised unintentional bias such as using adjectives indicative of a position on an issue, and intentional bias such as stating a position on an issue. In evaluating bias, bias can also have an intensity such that some content is indicative of agreement or disagreement with a given statement while other content simply leans toward or away from the statement.
Black box: A black box is a process that receives input data and provides output data in a somewhat predictable manner without providing understanding of the process used to map an input datum onto a resulting output datum.
Converse query is used herein to refer to a query that is related to the hypothesis in a somewhat inverse fashion. For example, prefers Coke® to Pepsi® has a converse query of prefers Pepsi® to Coke®. That said, oftentimes converse queries are only approximately converse a hypothesis due to other options or information. For example, likes Pepsi® might be seen as converse to likes Coke®, but in fact there are many soft drink options beyond Coke® and Pepsi®. Similarly, in political questions liking a candidate is usually evaluated against likely successful candidates and outliers are often not even considered.
Correlation engine: A correlation engine is a type of classification engine that after training correlates input data to output results. Correlation engines are typically black box processes that achieve a trained goal in an unknown fashion.
‘for’ is used herein and in the claims that follow to indicate a bias or stance relative to a query or statement; ‘for’ as used herein refers to a positive response to a query or a stance for a statement or hypothesis.
Statistically combine refers to a combination of values that is determined statistically to reflect some information sought through said combination. For example, averaging is a statistical combination of values as is summation.
Semantic analysis is a process wherein words and phrases are analysed to extract information from content. For example, semantic analysis is useful to read text and determine what the text intends to say.
Stance refers to a position indicated by bias within content. For example, stance is a position stated within the piece of content; alternatively, stance is a position determinable from the piece of content that is not stated therein. Further alternatively, stance is estimable from a piece of content but not easily measured or detected.
Stance direction indicates a lean or bias—for or against—in a stance regardless of how much the lean or bias is for or against. Thus a stance can lean for or against without being completely or definitively for or against.
Stance strength indicates how much lean or how biased in a stance direction a measured stance is. For example, a stance that does not condemn a position is less strong than a stance that supports the same position.
Training is a process in design and implementation of correlation engines wherein the engine is presented with input data and known output data for the input data. From the known output data and from the input data, the correlation engine forms a model that is used in correlating input data to unknown output data.
Training data: Training data is data used in training a computer system. Typically, training data includes known ‘Input data: Output’ data pairs.

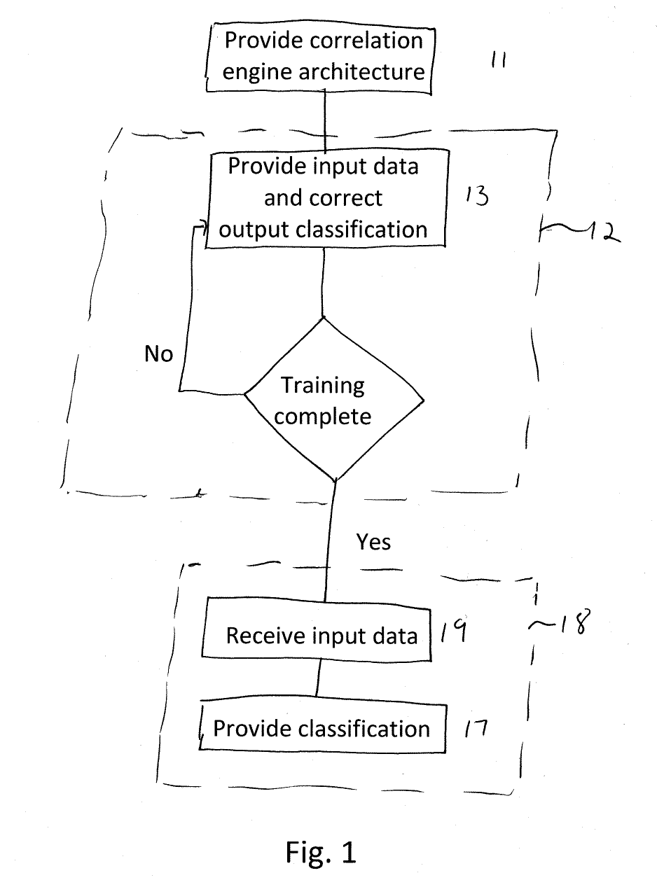

Referring to FIG. 1, shown is a simplified flow diagram of a process for creating a correlation engine. A correlation engine architecture is implemented at 11 resulting in a first process. The resulting first process is placed in training mode 12. In training mode 12, the first process, an implementation of the correlation engine architecture, is provided with a plurality of input values and for each input value an associated ‘correct’ response at 13. For example, a picture of a wolf is provided along with the correct output value “wolf.” Another picture, this time of a dog, is provided with the correct output value “dog.” With enough training data, the correlation engine is trained to classify pictures into at least two different classes—dog and wolf—for normal use. The classification engine is a black box that simply provides a classification output value in response to an input picture. How it determines the classification is somewhat unknown.

Then the correlation engine is taken out of training mode 12 and placed in operational mode 18. An input data value, in the form of a picture, is provided at 19. An output value reflective of a class of the input data value is provided from the correlation engine at 17.

In contrast to AI, most humans do not rely on experts for most of their knowledge. Humans often rely on self-reported information and observation. Your parents teach you colours, names, animal names, and flower names, but as Richard Feynman was noted to have expressed, these are not intelligence, they are labels; the intelligence is what he was taught by his father, that a bird lays an egg and the egg hatches into a small baby bird that grows up to be the same type of bird as its parents. Intelligence, according to Dr. Feynman comes from nature and observation instead of from labeling.

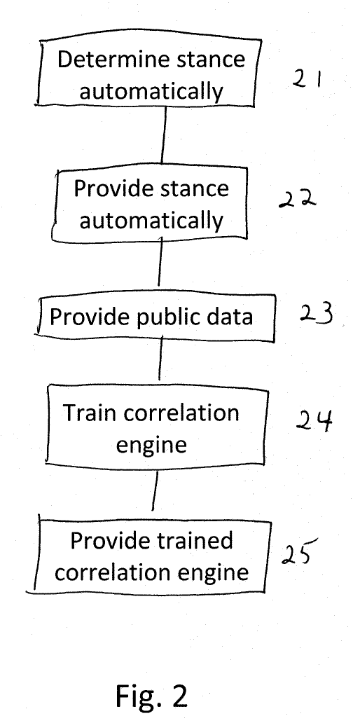

Referring to FIG. 2, shown is a simplified flow diagram of a process for resulting in a correlation engine that follows a different learning method according to an embodiment. Here, stance detection, for example as described in U.S. Patent Application 63/591,785 filed on Oct. 20, 2023 and titled Method and System for Automated Stance Detection and incorporated herein by reference and U.S. patent application Ser. No. 18/140,860 filed on Apr. 28, 2023 and titled Method and System for Sentiment Analysis and incorporated herein by reference, is performed to determine automatically an overall stance for a given user at 21.

The determined stance is provided to a correlation engine in training mode as output classification data at 22; input data at 23 for training the correlation engine relates to publicly available data relating to the given user, an individual associated with the stance, such as social media data or other data. The correlation engine is trained at 24. Once trained, the correlation engine forms a classifier at 25 based on the determined overall stances and other information about the individuals associated with the determined overall stances. For example, the classifier classifies a stance for a new individual based on their publicly available data. The classifier, in effect, results in each person being classified in accordance with automatically determined stances of a prior known group of individuals.

The classifier is general in nature and is useful for classifying unknown individuals based on the training and resulting correlation engine. A stance determination with a Yes/No answer results in a correlation engine that classifies individuals into two groups. Stance detection with more possible stances, for example 5 possible classifications-stances, results in a correlation engine that classifies people into more than 2 groups. Of course, two classifiers, each with a Yes/No answer classifies individuals into 4 possible stances (Y-Y, Y-N, N-Y, N-N).

Referring again to FIG. 2, a simple example involves a single group into which people are included or excluded. A stance is determined for individuals within a group dividing the group into people who are ‘for’ Pepsi® and those who do not have a pro-Pepsi® or ‘for’ Pepsi® stance. For example, a group of people in a defined social media group relating to soda is divided based on apparent stance determined based on affiliation and common posting patterns. As an example, Pepsi® executives are considered to be for Pepsi®; people who repost the executives' posts are also determined to be for Pepsi®. Based on the stance detection, a correlation model is formed by training a correlation engine with the determined group being for Pepsi® and those not in the determined group being NOT for Pepsi® for classifying Americans, in general, into two categories-the group of people who are for Pepsi®/the group of people who are NOT for Pepsi®—with input training data based on other information that is known for each individual whose stance was determined. For example, a person's twitter® feed is provided as input data to the classifier and correlated to determine a stance classification. In such an example, the method provides a trained correlation engine for grouping Americans into two distinct “classes” based only on their twitter feed data.

The correlation engine can be built through training, but a semi or fully automated correlation engine forming process is advantageous. Here for example, semantic analysis is used to extract extreme supporters of a given position. For example, people who clearly love Pepsi®. These individuals are then used as a reference group. In an embodiment, the reference group is detected using a simple text-based approach, like semantic search or lexical search.

Once a reference group is defined, their Pepsi® related posts≤of the “I love Pepsi®” reference group-are compared to posts over the past year of other people. Those people who correlate to the reference group are then used as training output data of the category “I love Pepsi®” for training a correlation engine; the input data is social media feed data of the same people. The correlation engine relies upon the obvious cases to generalize and then uses the general group to find latent indicators for non-obvious cases. For example, a person who loves Pepsi® may also buy beverages at Taco Bell (which only sells Pepsi® products). Posting about buying beverages at Taco Bell or posting photos of beverages from Taco Bell becomes a latent indicator and is learned by the correlation engine.

An explanation based on a geometric approach would be that the social history of each person is mapped into an embedding space. Having a dimension for each word or phrase in the social history of each user would introduce a lot of noise. The obvious cases, like “I love Pepsi®”, reduces the embedding space to one dimension—the mention of Pepsi® and value going from +1 (Love) to −1 (Hate). Because this reduction requires a person to mention Pepsi® and whether they love it or hate it, it is not very useful in a generalised solution.

The latent attitudes discussed above, like purchasing beverages at Taco Bell, expand the embedding dimension to be large enough that we have good differentiation but small enough that signal to noise remains high. Viewed this way, classification without training is a dimensional reduction problem.

The converse query is performed similarly. One nice feature of the geometric approach is that choosing the correct embedding, the correct first query, means the converse query is the inverse vector of the first query. That said, incorrect converse query selection is usually not a serious issue since most selected converse queries are still close enough to inverse or converse the first query.

Entailment is a formal logic approach for determining if statement Y follows from statements X1. . .Xn. For example, if statement X1 is “Taco Bell only serves Pepsi®” and statement X2 is “I love drinks at Taco Bell”, then through the application of formal logic we can prove that the statement “I love Pepsi®” may follow, but the statement “I hate Pepsi® products” is unlikely to follow.

Each statement X1. . .Xn can be a separate post. Then applying entailment on the social history can tell if the statement I love Pepsi® follows from the posts or is at least logically consistent therewith. Similarly, the converse query is used to classify those people who hate Pepsi®. In many cases the statement “I love Pepsi®” cannot be determined from the social history and those people are not classified.

The rules for entailment can be encoded in a general-purpose correlation engine, such as a deep learning neural network or an LLM. The general purpose correlation engine is only trained on the logic of entailment, not how people feel about Pepsi®. Thus, the LLM only determines logical consistency according to the rules of entailment.

Another solution is performing a dimensional reduction of the embedding space. Taking social history and creating an embedding space for that social history is well understood. Once the embedding space is created, it forms a manifold—a high dimensional structure potentially having complicated global non-Euclidean geometry.

By locating a first query and a converse query to the first query and within the embedding space, a linear dimensional reduction, such as Principal Component Analysis, around these points loses global geometric properties of the space. In this case, a property that the inverse vector from the query points to the converse query is lost. That said, the loss is often acceptable. A way of reducing the dimensions without losing global information is normal form reduction. Normal form reduction decomposes the manifold into lower dimensional basis that preserve global manifolds. This is based on geometric structures within the manifold. So flat structures, which will not contribute to the global geometry, are removable. What is left is the “curved” space that links the first query and the converse query.

The social history of a person within this space has 1 of 3 predetermined outcomes for each individual: 1) all the dimensions applicable to the social history have been removed so the individual cannot be classified; 2) The remaining dimensions put the social history near the query point allowing for a first classification; or 3) the remaining dimensions put the social history near the converse query point allowing for a second other classification. Historically, it is the first group that is highly problematic. By using only the second and third groups for forming reference groups and then using the reference groups to further define a first and second group that correlates with the reference group about the first query or about the converse query, a portion of individuals within the first group are classified. Using those to form a correlation engine allows for a classifier that is automatically determined and yet is reasonable in its performance and results.

How close the history is to the query or converse query gives the degree that a person likes or hates Pepsi®. Alternatively, a person's affiliation with similar activities and statements relating to Pepsi®, either directly or peripherally, are used as indicators of a person's classification. For example, people who share similar drink announcements to those shared by people known to like Pepsi®.

As noted above for entailment, rules can be learned by a general-purpose correlation engine, such as an LLM, for this approach as well. The LLM need not be trained on how people feel about Pepsi®, only how to recognize the normal forms within an embedding space.

The entailment embodiment and the normal form embodiment, while mechanically different, are substantially similar in effect when used as a foundation for an implementation within the present embodiments.

In entailment the system is looking for chains of statements like “Taco Bell only serves Pepsi®” and “I love drinks from Taco Bell” to prove that “I love Pepsi®” follows. In normal form reduction, Taco Bell and Pepsi® are geometrically related (the normal form) and so these dimensions are retained while other dimensions like “serves” and “drinks” are removed.

Optionally, both the entailment embodiment and the normal form embodiment are used simultaneously and logically combined—for example by selecting the overlap between sets of extracted classified individuals. Though in theory each should form a relatively similar set of classified individuals, in practice differences occur and those differences are optionally filtered to form a single training data set compatible with both approaches.

Once the basic classifier is constructed without training data or with automatically determined training data sets, then the classifier is useful as a generalised classifier for classifying people unrelated to those known to like Pepsi®. Advantageously, the correlation engine is automatically constructed and/or trained with data that is, in some embodiments, automatically determined. The above description provides a two-step process for stance detection. Other methods of automatically implementing a classifier are also possible.

Once the correlation engine is implemented, it is useful to, for example, highlight all American users of Twitter® who are for Pepsi®. The stance, “Is someone for Pepsi®?” appears to be absolute; someone either does or does not support Pepsi®. That said, in reality it presents three options for interpreting the stance—for Pepsi® (group 1), cannot be said to be for Pepsi® and therefore may support Pepsi® (group 2) or against Pepsi® (group 3). One may verify the result using available data instead of a correlation engine, or one may determine a stance “against Pepsi®” providing for all three classifications, where in theory one cannot be both for and against Pepsi®. Many people who correlate as being for Pepsi® will also have a stance automatically determined that they like Pepsi®.

Thus, the group of individuals determined to be for Pepsi® is likely similar regardless of training and stance detection methodologies.

In contrast, referring again to FIG. 2, a stance detection to determine, “Is this person a Liberal?” results in a stance determined based on a definition of “Liberal,” which is not a fixed concept. Two people may be very different in their Liberalism and yet both consider themselves Liberal. Thus, a stance relating to “Liberalism” is dependent upon the definition of “Liberalism.” This is in contrast to a defined stance, for example, “Is this person a free speech absolutist?”

When stances are subject to definition, different correlation engines trained with different data are potentially trained with data determined based on different definitions, for example of “Liberal.” The definition of Liberal is not absolute and would best be defined based on the seed group or users who are defined as A Priori Liberal. Therefore, even identical groups of people might result in different classification with different classification engines with slightly different concepts of “liberal.” As a specific example, in some countries, Liberal is a political party. Someone classified as Liberal in Canada supports the Liberal Party. A supporter of a Liberal Party in another country may have different classification criteria and of a liberal even moreso. Thus, classes and classification are very specific to the definition of stance for stance detection.

Advantageously, instead of defining the stance as for the Liberal Party, one might define stances as more absolute and then define the absolute stances as for the Liberal Party. A stance would then relate to an issue or to a small group of issues—for or against involvement in a particular conflict, for example—and then that issue is associated with a political lean; it is more often seen in supporters of this party or it is the official position of this party. Since automated stance detection is usable, people “for” a particular party can be classified and their stances on issues evaluated; in converse, people with certain stances can be evaluated and their party affiliation extrapolated.

Another example is for political stance, the term “Liberal” in Canada is different from the term “liberal,” as there is a Liberal political party. Unfortunately, on social media, many people do not capitalise their words correctly. That said, in a Canadian political conversation, Liberal and liberal are most likely referring to the party and not the adjective. Similarly, other terms have different definitions depending on context, but within a known context have very well-defined meanings.

In accordance with FIG. 2, based on the automated stance detection results, a correlation model is formed for classifying Americans, in general, into two categories—liberal/NOT liberal-based on other information that is known about them. For example, a person's Twitter® feed is provided as input data to the classifier. Thus, the method provides for grouping Americans into two distinct “classes.” The classes are distinguished based on automated stance detection.

Once the correlation engine is trained, it is useful to, for example, highlight all American users of Twitter® whose data indicates that they are “liberal” in view of the definition used for the stance detection; it is also useful for searching, surveying, etc. Thus, even though the stance detection does not have an absolute universal answer, the correlation engine that results is very useful.

The training data for distinguishing liberal Americans is either determined by extracting a single set of individuals based on the definition of liberal or by extracting multiple sets, one for each aspect of the definition of liberal and then combining the multiple sets, for example by taking the overlapping portion of all the sets. If liberal is defined as supporting free speech, equality before the law, and one person one vote; then the system could identify politicians that are liberal and then find groups supporting them to form the training data set.

Alternatively, the system finds the three groups of individuals and takes the overlap, intersection, of the three groups. This second method is more useful as the number of classifications rises, as it allows for a classification of “mostly liberal.”

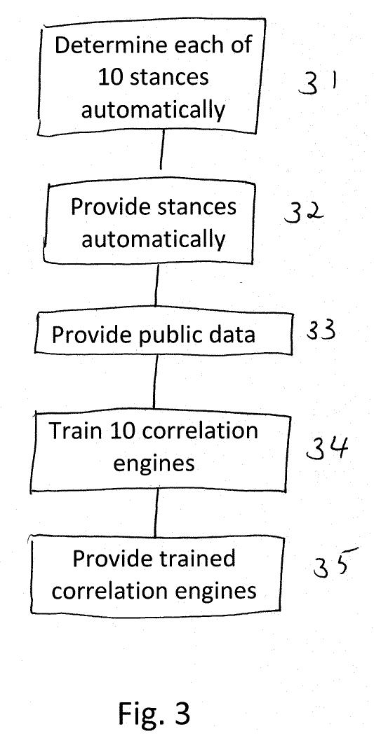

Referring now to FIG. 3, shown is a process of FIG. 2, but extended to 10 stances each determined for a same sample group of Americans at 31 and each having a limited number of potential stances. Alternatively, stances are determined for different sample groups of Americans, each having a limited number of potential determined stances. Because correlation results are extensible to a general population, the stance detection is preferably performed on a large enough group to allow for a reasonable correlation model but need not be determined for a same group, repeatedly. The stances are provided for use in training at 32 along with publicly available information at 33. 10 correlation engines are trained at 34. Thus, as shown in FIG. 3, at 35 ten correlation models result from ten different stance determinations, allowing each American to be grouped into each of ten categories—Yes/No for each of ten questions. If Americans distribute evenly, this results in approximately 1,024 groups (2\hat{ }10) of about 400,000 people each. The groups are formed without conventional training on known training data.

For example, three stances might be the following:
1. For Pepsi®?
2. For Coca Cola®?
3. Against soda drinks?
   As is evident, these questions appear to correlate such that someone who likes Pepsi® probably doesn't like Coke® and someone who dislikes Soda likely does not like Coke® or Pepsi®.

Once the 3 correlation functions are determined, a population is divisible, each into 3 categories—Yes or No for each question. There are 8 groupings of categories for classification, but likely the population will not distribute evenly into all of them.

By performing many stance detections of many groups of individuals, many classification engines are formed and a population becomes divisible into classifications based on existing available data, for example their Twitter® feeds. Thus, relying upon stance detection of a group, the system allows for dividing populations for many purposes including advertising, demographics, analysis, polling, feedback relating to announcements, actions, etc.

In a country with many political parties, party positions often overlap on some issues. Thus, when the 3 classification engines are trained on political issues, such an issue-based classifier allows a population to be classified based on 3 relevant stances on political issues and then individuals are associated with a closest political party based on the 3 resulting classifications.

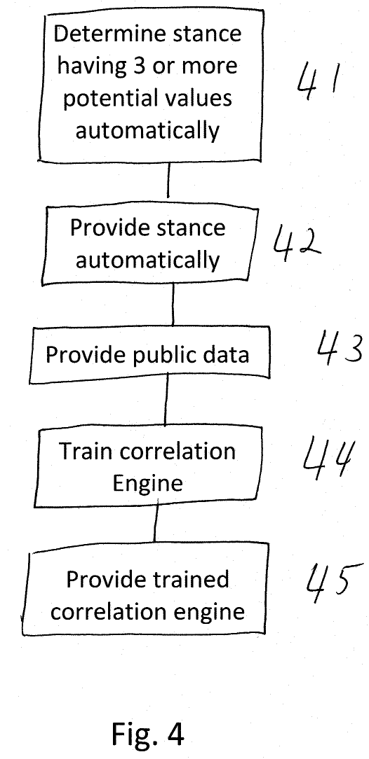

Referring to FIG. 4, shown is a simplified method of using stance detection results to “train” a correlation engine. At 41, stance detection divides respondents into N classes. For example, a stance detection with three possible answers divides a group of respondents into 3 classes. The individuals, their stance is provided 42, and other data relating to them such as social media feed data is provided to a correlation engine for training at 43. The correlation engine is trained at 44 and is then suitable for forming a correlation for the members of each class such that, at 45, provided another individual with similar social media feed data, the correlation engine will estimate a same class. Thus, a classification engine results for the group to classify a population into N classes. In an embodiment, a single stance detection detects between the N classes. Alternatively, multiple stance detection operations to detect multiple stances are used to detect between the N classes. Further alternatively, a separate stance detection is used for detecting a single stance, such that for N stances, N classification engines are relied upon.

In an embodiment for determining political stance, a single stance detection operation divides a group into groups that support each political party. Alternatively, a stance determination for the group is made for each party such that in an N party system, N stance detection operations are performed. Further alternatively, stance detection is performed to group individuals along some measure, for example conservatism. In each case, individuals are grouped into N categories. Alternatively, individuals are grouped into each party non-exclusively such that some individuals might have stances supporting more than 1 party.

The process of FIG. 4 does not include a professionally curated reliable data set provided for supervised training, nor does it involve a painstaking process of creating a training data set. For example in the USA, stance is determined based on perceived support for presidential candidates as opposed to basing it on party platforms or estimations of where an individual is on the political spectrum-Right-Left leaning. Further, the classification engine that results is applicable to real world data in a somewhat meaningful way—not just to data analysable for political lean. In some instances, the classification engine is a reflection of the detected stances as opposed to ground truth; in other instances, it is a close approximation to ground truth. In yet other instances, it is a direct reflection of ground truth.

In selecting the group of individuals for whom stance detection is performed, statistical errors still matter. For example, selecting 1000 random people who voted for a particular candidate and determining a stance for, “Do you support the candidate” is likely not generalizable to the broader population since each of them is known to have voted for said candidate. A closed group relating to a specific purpose is a poor sample for stance detection relating to that purpose, since the stance is typically known. Oftentimes, a group relating to an issue is large and diverse with members supporting both sides; such a group is preferred to allow a trained correlation engine that results in meaningful distinctions between participants. Other times, a group is focused and small, and yet it is still often preferable to select a sample group that is large and diverse for automated stance detection and training of the correlation engine in order to ensure that the trained systems generalises to larger populations. For example, selecting a group of 1000 people who voted for candidate A and 1000 people who voted for candidate B (did not vote for candidate A) allows for training for two groups. Providing samples for each candidate would result in a classifier that could classify for each candidate or for Candidate A—NOT(candidate A) Thus, selection of populations and stances is important to get broadly usable results. Selection of populations is equally important if the resulting classification engine is to work only with known populations. For example, a classification engine for classifying women is best trained from a selected group of women for whom stance detection is performed.

For example, some individuals are known to have the stance, “support the candidate; ” the candidate likely supports themselves. Any people who re-tweet many of the candidate's tweets likely supports the candidate. Thus, with a small group of a priori supporters of the candidate or, alternatively, with a group having an assumed stance, stance detection is performed on the larger group and said stance detection is used to train a correlation engine to result in a classification engine for classifying general individuals into groups supporting the candidate—for the candidate—and NOT supporting the candidate—either against the candidate or without strong support for either candidate. Examples of groups with assumed stances might include political rally attendees, politicians within a political party, etc. Within the Coke® vs Pepsi® debate, Pepsi® employees might be assumed to like Pepsi® more, though this need not be the case for all employees.

In another embodiment, survey results are used in place of automated stance detection. A survey is provided to a group of users with a question and the answers to the question are used as a stance of each person who answers the survey. Thus, a survey question such as “Are you a member of the Republican party?” and their associated answers is used in place of automated stance detection. Alternatively, it is only used to find the a priori group having a known stance.

Here results remain useful even when the answers are untrue, and in fact specifically because they are untrue. In a self-reported embodiment, it is the reported answer that forms the results from a trained correlation engine and not a ground truth answer. Of course, when all reported answers are ground truth, then the correlation engine forms a classifier for classification in accordance with the survey question.

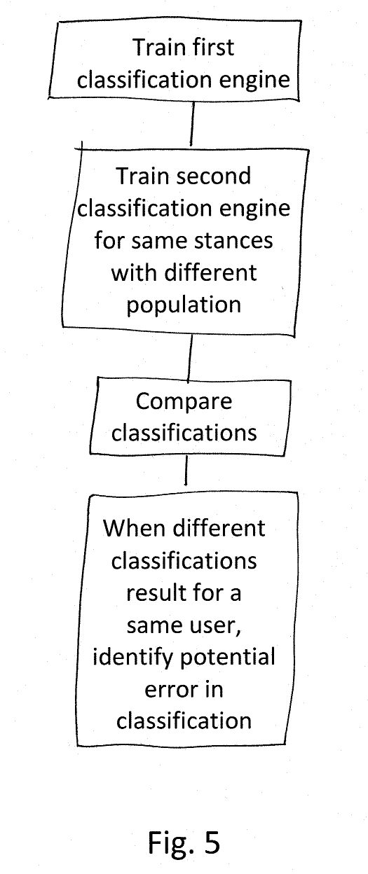

Referring to FIG. 5, shown is a simplified method of using stance to train a classifier wherein a stance for a first user is in error, for example the first user makes an error responding to a question or the first user retweets a message accidentally. Here the classifier classifies the first user erroneously—correctly based on the determined stance but incorrectly based on objective truth—and as such might be seen to be inferior to other classifiers. However, if the same stance detection were performed for other groups of individuals over time, the first user is classified differently by some classifiers. As such, a classification of the first user has a confidence level below a classification of a user that is consistent across correlation engines. Importantly, a confidence level is useful to over-include or under-include users within classes for different purposes. For example, under-including may lead to omission of potential opportunity, but over-including may lead to additional work to identify opportunity. Thus, different applications will choose one or another.

In an embodiment, the system corrects the incorrect classification when enough evidence of error exists. For example, when 80% or more of the classifiers classify the first user differently, they are always classified differently. Such a classification system corrects some self-reported errors and also corrects correlation results over time. An example would be the question, “Do you use a smart phone?” The answer in 2000 would have been “No” for most people in North America whereas today it will be mostly “Yes.” Determining stance every month would allow the system to transition the classification over time as smartphone availability changed.

An analogous approach to correcting classifiers is also applicable by determining the classification errors, it is possible to filter or retrain a classifier to correct for errors. This process can occur automatically or it can include a human in the loop such that a person is notified of the misclassification that is detected and can choose to retrain the classifier or not, for example by removing the incorrect training data from the training data set.

This same transition works within societal changes, demographic changes, etc. when determined through automated stance detection or when determined through manual stance detection. Advantageously, this transition is very useful in gauging public opinion, which changes frequently and rapidly. It is also useful in identifying changes in group values over time. Determining that someone supports a political party and has particular positions on significant issues sometimes leads to noticing that the significant issues change for the same political party over time. Some changes are natural progress; others are counter to the original positioning of the party and reflect a change in party positioning.

Further advantageously, though likelihood is determinable mathematically, in some embodiments, classification results are provided to another correlation engine to determine, based on results, a likelihood that an individual is classified correctly. Thus, even the likelihood of accuracy of results is optionally determined with an unsupervised correlation engine based on self-reported results.

Of note, oftentimes it is sufficient to identify highly partisan individuals. By filtering those that are less likely to be highly partisan, one often achieves a group of sufficient size that is highly partisan for analysing partisan positions, partisan influencers, and issues that are important to people who are highly partisan.

Likewise, using the above-described method allows for identification of less partisan individuals. These individuals might be described as those whose views rest within one category but near another—right leaning Democrats and left leaning Republicans. In some world views, these individuals are available to be moved from their class through some form of influence. Here, highly partisan individuals are extracted and form a separate group. These highly partisan individuals are then used in automated stance detection of partisan individuals and individuals with a sought-after stance. Thus, those individuals so identified become a group for training a correlation engine to identify individuals with a given stance. Of course, the process of distinguishing stance and how much an individual needs to lean in a particular direction to be part of the group, is a matter for the automated stance detection designer. One designer might include all people who lean slightly democrat while another seeks people who are clearly demarked as democrat and unlikely to change position. These automated stance detection processes result in different groups and therefore in different trained correlation engines.

When the designer is seeking information for swaying people, it is often people with a slight stance that are easiest to move. Identifying individuals who are likely easiest to influence is an important feature for some users and is achievable by breaking a greater stance—e.g. political party—into smaller stances—e.g. stance on each issue.

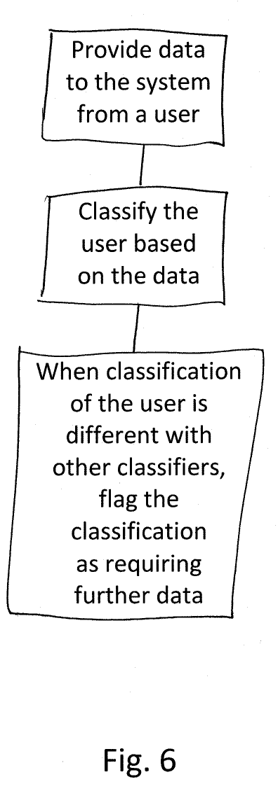

Referring to FIG. 6, shown is a simplified flow diagram of a method of learning about a user. The first user provides information, for example that they are American. The initial correlation engine classifies them as “American,” because this is what they asserted. Over time, more correlation engines are trained to classify Americans, for example based on different stance definitions, based on automated stance detection and based on other information. When the first user is not commonly classified by the other correlation engines as “American,” the system then flags the classification by indicating that it is unreliable. This is useful, for example, in filtering highly partisan individuals from the highly partisan group used in automated stance detection in order to prevent gaming of the overall system. Alternatively, the person is labeled highly partisan by a third party, but that label is or becomes inaccurate.

In effect, people learn about people in a similar fashion. There is no permanent real objective truth about a person's favourite food. The way we learn about food preference is by observation over time. Often, the favourite food changes over time. Also, favourite food may be situational in nature - different at home from at an Italian restaurant. When expectations and observations align, we tend to believe the expectation. When not, we tend to doubt its present accuracy.

Thus, a constellation of overlapping determinations, for example overlapping correlation engines for classification based on self-reported data, allows for recording of the self-reported expectation and evaluating behaviour to assess against the self-reported information. Some unreliable information is true, for example the user did love ice cream but has since been diagnosed with diabetes. Other unreliable information is false, for example the user was employed to promote a certain food. Yet other unreliable information is merely unreliable, the user's tastes change over time.

Numerous other embodiments are envisioned without departing from the spirit or scope of the invention.

What is claimed is:

1. A method comprising:
providing a first correlation engine;
in a training mode of operation, providing to the first correlation engine for each of a first plurality of first users, a plurality of first available data about each first user of the first plurality of first users and a first stance of each first user relating to a first query; and
in an operational mode providing to the first correlation engine a plurality of available data relating to a first new user, the first correlation engine providing a first output estimated stance for the first query for the first new user.

2. A method according to claim 1 wherein the plurality of first available data comprises social media feed data.

3. A method according to claim 2 wherein the first stance of each first user is automatically detected.

4. A method according to claim 3 wherein the first stance of some first users is automatically detected by correlating user statements on social media with statements made by individuals having a known stance.

5. A method according to claim 3 wherein the first stance of some first users is automatically detected by correlating information shared on social media with information shared by individuals having a known stance.

6. A method according to claim 5 comprising:
determining a first group of users of social media having a known stance for the first query; and
determining a second group of users of the social media sharing common elements of social media feed data with the determined first group, wherein the common elements are indicative of sharing a same stance for the first query as the first group, the same stance forming the first stance.

7. A method according to claim 1 wherein the first stance is determined by providing each user of the first plurality of first users a survey question and wherein the first stance is one of an answer to the survey question and a stance derived from the answer to the survey question.

8. A method according to claim 1 comprising:
providing a second correlation engine;
in a training mode of operation, providing to the second correlation engine for each of a second plurality of second users, a plurality of first available data about each second user of the second plurality of second users and a second stance of each second user relating to a second query, the second stance different from the first stance of the first plurality of first users; and
in an operational mode providing to the second correlation engine a plurality of available data relating to a second new user, the second correlation engine providing a second output estimated response to the second query for the second new user.

9. A method according to claim 8 wherein the second plurality of available data and the first plurality of available data comprise data from a same data store.

10. A method according to claim 9 wherein the first stance is approximately converse to the second stance.

11. A method according to claim 10 wherein the second stance is automatically determined for each of the second plurality of second users.

12. A method according to claim 11 comprising:
in an operational mode providing to the second correlation engine available data relating to the first new user, the second correlation engine providing a second output estimated response to the second query for the first new user.

13. A method according to claim 12 comprising:
comparing the first output estimated response to the first query for the first new user and the second output estimated response to the first query for the first new user to provide a comparison result.

14. A method according to claim 13 comprising:
determining a reliability of first output estimated response to the first query for the first new user and the second output estimated response to the first query for the first new user in dependence upon the comparison result.

15. A method comprising:
automatically determining a stance for a first group of users within each of a plurality of groups of users, at least one of the same stance and a correlated stance determined for members of each first group of users;
using the determined stance as correct output values for training a plurality of correlation engines, each correlation engine trained with each determined stance from a group of the plurality of groups and data available and relating to users within the group of the plurality of groups for whom a same stance is detected;
for each user within a population of users, executing each of the plurality of correlation engines to determine a plurality of output values, each output value relating to a different correlation engine; and
comparing output values from the plurality of output values one against another to determine at least one of a degree to which the output values relating to a particular user and a likelihood that the output values relating to a particular user are correct.

16. A method according to claim 15 wherein the at least one of a degree and a likelihood is a largest number of output values relating to a same stance to a total number of the plurality of output values.

17. A method according to claim 15 wherein the same stance is automatically determined.

18. A method according to claim 17 wherein the same stance is automatically determined based on a correlation of social media activity of a first user compared to social media activity of a user having a known stance.

19. A method comprising:
providing a first correlation engine;
automatically determining a first stance of a first user in dependence upon users having a high likelihood of having a known stance;
using the first stance as known output data for training the first correlation engine;
using publicly available data relating to the first user as training input data for training the first correlation engine; and
training the first correlation engine with the known output data and the training input data.

20. A method according to claim 19 wherein the publicly available data comprises social media feed data.
